(19) United States
(12) Patent Application Publication
(10) Pub. No.: US 2006/0066438 A1
(43) Pub. Date: Mar. 30, 2006

(54) Method and system for controllably and selectively securing a portable computing device to a physical holding device

(76) Inventors: David Altounian, Austin, TX (US); Arno Penzias, San Francisco, CA (US)

Correspondence Address: FORTKORT GRETHER + KELTON LLP, 9442 N. Capital of Texas Hwy., Suite 500, AUSTIN, TX, 78759, US

(21) Appl. No.: 10/951,326

(22) Filed: Sep. 27, 2004

(51) Int. Cl. H04Q 1/00; G05B 19/00

(52) U.S. Cl. 340/5.53; 340/5.21

(57) ABSTRACT

A method and system for controllably and selectively securing a portable computing device to a physical holding device includes a physical holding device for receiving a portable computing device. A locking mechanism locks the portable computing device to the physical holding device. A security application associates with the portable computing device for responding to an authorization input for generating an electronic locking mechanism control signal. An actuator mechanism responds to the electronic locking mechanism control signal to actuate the locking mechanism in locking the portable computing device to the physical holding device.

### FIELD OF THE INVENTION

This invention pertains to portable computing devices, such as a tablet computer and ways of securing and preventing unauthorized access to such devices and, more particularly, to a method and system for controllably and selectively securing a portable computing device to a physical holding device.

### BACKGROUND OF THE INVENTION

For many applications, tablet computers and other portable computing devices significantly facilitate the recording of and access to personal data, proprietary algorithms, and other forms of sensitive or highly valued data and programs. As a result, such computing devices are of significant value, not only because of the processes that they enable, but also because of the data that they may hold. Moreover, many devices such as tablet computers provide secure wireless access to many networks or on-line systems. To protect this access tablet computers and similar devices must be secured from unauthorized use and access.

Known security measures for tablet computers provide security against unauthorized access to the various programs and data that the tablet computer holds using standard password software and similar authentication programs that use software to assure that only authorized users have access to the tablet computers contents. Unfortunately, the only known method or system assures that the tablet computer will not be stolen or otherwise physically removed from its location of use is a physical lock that is not user specific. In the event of unauthorized use, theft or removal seriously damaging circumstances may follow from unauthorized persons seeking or accessing such data or programs. In addition, the replacement costs following theft are simply not desirable or acceptable, if some alternative way of securing a protecting these devices could be provided.

There is a need, therefore, for a tablet computer holding device or docking station stand that prevents an unauthorized person from using, stealing or removing the tablet computer.

There is a need for a method and system that permits a user to control the time or circumstances at which a tablet computer may be physically removed from a secure location.

### SUMMARY OF THE INVENTION

The present invention provides a method and system for controllably and selectively securing a portable computing device to a physical holding device which substantially eliminates or reduces the disadvantages and problems associated with prior methods and systems for preventing unauthorized use of and access to a tablet computer and similar devices.

According to one aspect of the present invention, there is provided a method and system for a method and system for controllably and selectively securing a portable computing device to a physical holding device which includes a physical holding device for receiving a portable computing device. A locking mechanism locks the portable computing device to the physical holding device. A security application associates with the portable computing device for responding to an authorization input for generating an electronic locking mechanism control signal. An actuator mechanism responds to the electronic locking mechanism control signal to actuate the locking mechanism in locking the portable computing device to the physical holding device.

A technical advantage of the present invention includes the use of the same or similar security applications as may be used to provide controlled access to software and data to also provide controllable and selectable physical access. As a result of the control that the present invention provides, a user may control not only who, but also how a person may physically access the tablet computer.

A further technical advantage of the present invention includes the ability to employ the physical security application of the present invention in many different environments and applications. As a result of the present invention, there are many more business and professional environments in which a tablet computer or similar device may find extremely valuable service.

Other technical advantages are readily apparent to one skilled in the art from the following FIGUREs, description, and claims.

### BRIEF DESCRIPTION OF THE DRAWINGS

For a more complete understanding of the present method and system for controllably and selectively securing a portable computing device to a physical holding device, reference is now made to the following description which is to be taken in conjunction with the accompanying drawings and in which like reference numbers indicate like features, and further wherein:

FIGS. 1 and 2 show a tablet computer front side view and bottom side view, respectively, for illustrating certain aspects of the present invention;

FIG. 3 shows a tablet computer residing in and connecting to flexible docking station possessing the physical security system of the present invention;

FIG. 4 presents a lock mechanism which may be used for the present invention in physically securing a portable computing device;

FIG. 5 illustrates one of many possible uses for the physical security device of the present invention in a healthcare services environment; and

FIG. 6 depicts yet another implementation of the present invention such as a police or other utility service vehicle which may secure a portable computing device with the aid of a security device such as that of the present invention.

### DETAILED DESCRIPTION OF THE ILLUSTRATIVE EMBODIMENTS

Preferred embodiments of this invention are described herein, including the best mode known to the inventor for carrying out the invention. Variations of those preferred embodiments may become apparent to those of ordinary skill in the art upon reading the following description. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

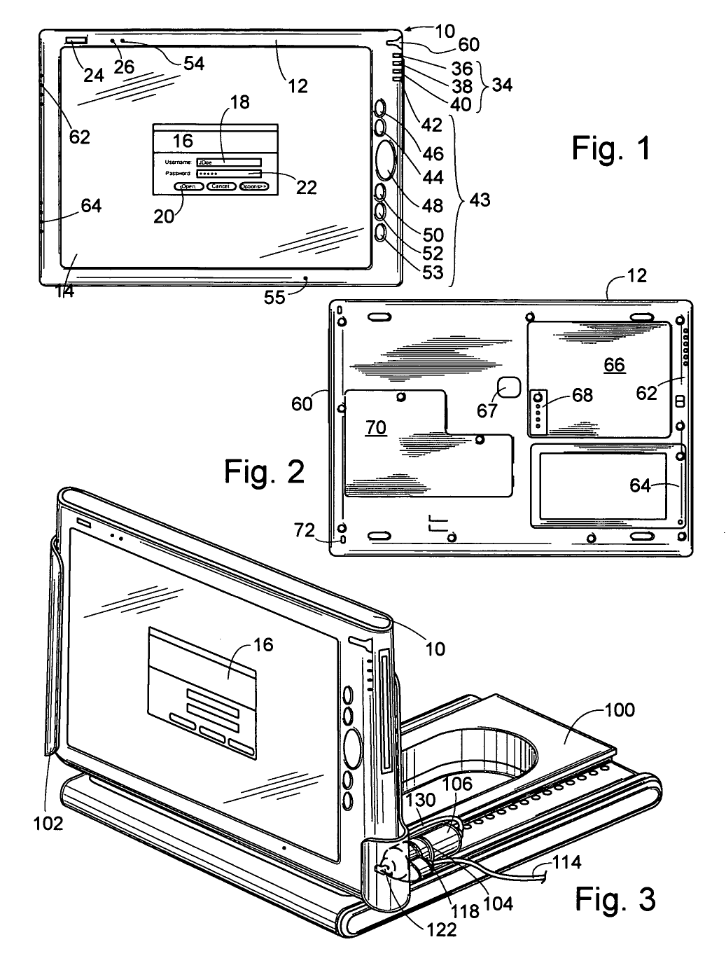

To illustrate the preferred embodiment of the present invention, FIG. 1 shows tablet computer 10, which includes casing 12 surrounding screen 14. Screen 14 shows login template 16, which receives a user name in user name field 18 and a password in password field 20. Upon entering a correct user name and password, a user may click on OK icon 22 to access programs operating on tablet computer 10. On tablet computer casing 12 appear fingerprint sensor 24, ambient light sensor 26, and microphones 28 and 30. Fingerprint sensor 24 provides a swipe-type sensor for scanning fingerprints and may be used for password management and security. Ambient light sensor 26 measures the ambient light and automatically balances display brightness of screen 14 in response thereto.

Along side 32 of casing 12, appears LED row 34, which includes power LED 36 for displaying power status, battery LED 38 for displaying battery status, hard disk drive LED 40 for displaying hard disk drive activity, and wireless LED 42 for displaying wireless activity and on/off status.

Tablet computer 10 also includes a number of function buttons 43, including escape button 44, function button 46, five-way directional control button 48, Hot Key #1 button 50, and Hot Key #2 button 52, all of which are described in detail and function in the Motion Computing Corporation publication, Motion Computing M1400 Tablet Computer User Guide, which publication is here incorporated by reference. Microphones 54 and 56 work at a natural distance to receive audio signals and are disabled when an external microphone is plugged in. Pen Post 58 receives the digitizer pen, which is a sensitive, electronic data-entry device designed in conjunction with the tablet computer display to which you can secure the pen with a plastic pen tether.

A PC card slot 60, along the side of casing 12 holds one Type-II PCMCIA card for memory expansion, an external Bluetooth cards, or other type of electronics card. Speakers 62 and 64 are integrated into casing 12 and may be muted upon connecting a headset or external speakers. Tablet computer 10 also includes an antenna cover for an 802.11 wireless networking antenna cover, a power switch for turning the tablet computer on and off, and AC power jack AC power connector for the tablet computer, an RJ-11 modem port Connector for a 56.6K V.90 modem, and RJ-45/LAN Standard RJ-45 connector for a 10/100 Mbps network, RJ-45 LEDs, a display LAN connection status a VGA connector, a standard DB-15 monitor connector for an external monitor, a docking connector for connecting the tablet computer securing docking station (FIG. 3, below), and USB ports.

FIG. 2 shows the bottom side of casing 12, which includes battery pack 66. Battery pack 66 is removable using release latch 67 and provides battery gauge 68, for indicating remaining battery charge. Memory/mini-PCI access bay 70 houses memory modules and a mini-PCI wireless card. In addition, security lock slot 72 fits a cable lock for securing the unit to a desk, etc, and provides a point of focus for the present invention.

FIG. 3 shows tablet computer 10 residing in and connecting to flexible docking station 100. Flexible docking station 100 is described in detail in U.S. patent application Ser. No. 10/175,581, filed on Jun. 6, 2002, which is here incorporated expressly by reference, and permits using tablet computer 10 as a desktop computer. Tablet computer 10 snaps into flexible docking station 100 and permits a rotation of tablet computer 10 from a portrait to a landscape viewing perspective for meeting a wide variety of application needs. In addition, flexible docking station 100 permits writing on the tablet computer screen 14 using a digitizer pen, at any angle, as well as storing flat for improved portability of the entire unit. Although not shown, flexible docking station 100 also includes three USB ports, an IEEE 1394 port, a VGA port, an RJ-45 Ethernet input, an Audio Output, and a microphone port. When combined with a keyboard and optical disk drive, flexible docking station 100 provides full desktop computing functionality through table computer 10.

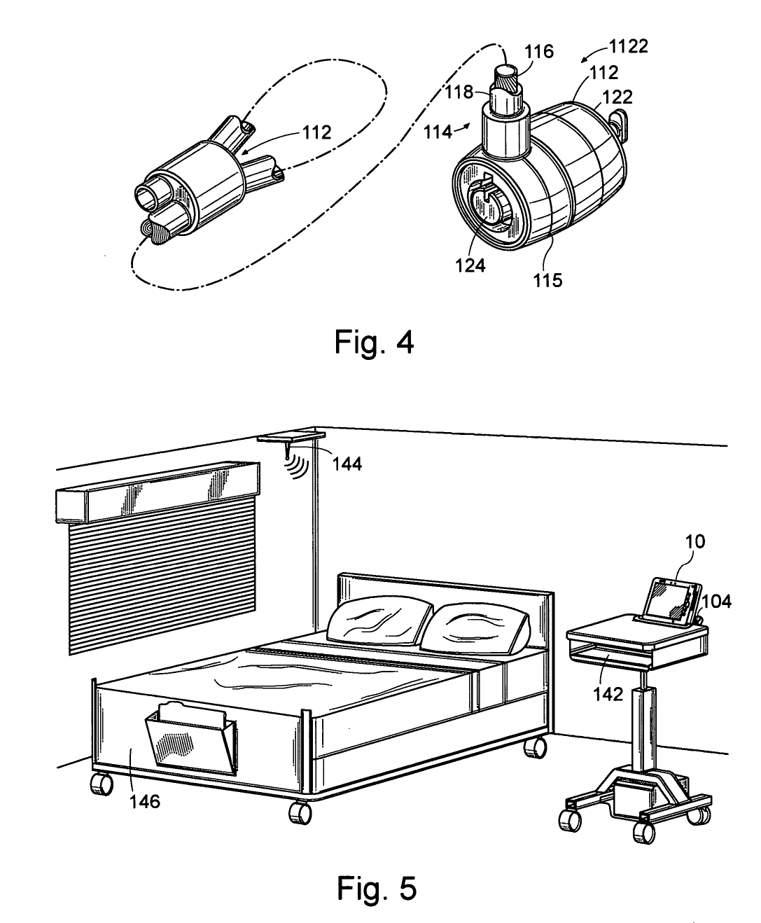

FIG. 3 also shows an illustrative embodiment of security device 104 which achieves the purposes of the present invention. Security device 104 contains a physical lock, such as the lock known as a “Kensington Lock,” as described in U.S. Pat. No. 5,372,752, said U.S. Patent being here expressly incorporated by reference. Security device 104 may include, for example, an axial pin tubular lock for use in securing portable computers and other devices having spindle-accepting ports, such as security lock slot 72 of tablet computer 10. Through actuator cable 130, control signals communicate from tablet computer 10 to security device 104. Security device 104 holds lock 110 (see FIG. 4) and may rigidly attach to flexible docking station 100. Security device 104 includes an actuator mechanism 106, which may be any one of many possible electromechanical mechanisms for receiving an actuation signal from table computer 10 and, in response thereto, causing lock 110 to lock or unlock. The circuitry of security device 104 is that needed to receive a signal from tablet computer 10 and provide an actuation signal to actuating circuit for operating actuator mechanism 106 in actuating, for example, a Kensington Lock motor. From security device casing 106 extends cable means 114, which may secure tablet computer to a physical locution such as a floor anchor or heavy furniture piece.

The present invention, therefore, makes effective use of the security software and the electronics circuitry of tablet computer 10, the rigid, yet multi-functional structure of docking station 100, together with a security device such as, security device 106 (including a Kensington or similar lock 110) for physically securing tablet computer 10 in an electronically controllable manner. For example, by combining the biometric technologies of fingerprint reading of finger print sensor 24 or voice recognition using microphones 28 and 30, tablet computer 10 may specifically identify one or more specific users according to their individual fingerprints or voice signature. Using such a method for identity verification and validation, the user will receive the authorized physical release or securing of tablet computer 10 in a docking station or similarly strong holder or station. By associating one or more locking mechanisms 110 of a docking station 100 with a tablet computer 10, the present invention may determine whether a potential user has the necessary authorization to use the secured tablet computer. If the potential user does not possess or use the correct authentication input, security device 104 will neither allow access or use of the tablet computer, nor will it make possible the use of the tablet computer within the docking station.

Although not explicitly needed for the present invention, a lock that may be used in security device 104 may a tubular lock 110 according to FIG. 4. In FIG. 4, lock 110 includes an outer shell having a forward portion 111 and a rear portion 112. In the preferred embodiment of the present invention, the forward portion 111 of the outer shell comprises a cable ring structure (not shown) which may receive cable means 114.

As shown, the preferred embodiment of cable means 114 for use in the present invention includes an internal core 116 formed from stainless steel aircraft cable and an external sleeve 118 formed from PVC or a like material. The internal core extends beyond the end of the sleeve 118. As illustrated, the distal end of the cable 114 is formed into a loop 120 in a manner well known to those skilled in the art. In operation of the lock 110, the loop 120 may be either connected to a stationary body by means of a second locking device (not shown) or passed over the rear end 112 of the tubular lock prior to insertion of the spindle into an appropriate locking port, thereby creating a locked circuit between spindle 122 of tubular lock 110 and the attached cable means 114. Thus, as spindle 122 moves from one position to another in security lock slot 72 of table computer 10, the locked circuit physically secures the tablet computer 10 in position.

As will be appreciated by those skilled in the art, the use of PVC sleeve 118 to cover the cable means 116 permits the cable means to be wrapped around stationary objects prior to the loop 120 being disposed over the lock 110 of the present invention without damaging the surface of the stationary object. Presently, the tablet computer 10 provides input via a fingerprint sensor 24, a password using login template 16, and a PCMCIA card input using a smartcard or other authorization electronics reader. There may be other ways to provide the needed authorization for actuation security device 104 of the present invention. The present invention may incorporate a password management system in association with security device which includes a fingerprint reader built into the tablet computer lets which permits scan the user's fingerprint to log onto the tablet computer and perform other functions such as accessing email, e-banking, paying bills online, or accessing network resources. The password management system provides a secure and convenient system for managing passwords. When implemented within the security policies of your work environment, the password management system authentication tools add another layer of security for passwords, files, and other logons. The following section provides basic information about setting up and using the management system.

The present invention also provides an actuation mechanism for associating a number of tablet computers 10 together to permit the physical removal of more than one tablet computer 10 upon the receipt of an actuation signal from a master or controlling tablet computer. Thus, for example, in a class room using a set of tablet computers 10, the present invention would permit the physical of the tablet computers via central network control signal (such a control signal may, for example, come through wireless network) to release the classroom's tablet computer, using a single “release” command.

FIG. 5 illustrates one of many possible uses for security device 104 of the present invention as in a hospital room 140 in which a wheeled cart or other holding device 142 may receive tablet computer 10. Wheeled cart holding device 142 may include the electrical and electronic connections similar to that of flexible docking station 100. Upon inserting tablet computer 10 into wheeled cart holding device 142, security device 104 may physically lock tablet computer 10. This may occur through the use of a security application, such as login template 16, or by some other means. For example, using fingerprint sensor 24, tablet computer 10 may be securely locked into wheeled cart holding device 142. Conversely, for removing table computer 10 from wheeled cart holding device, fingerprint sensor 24 or some other biometric device may be employed that will actuate security device 104. Also, PCMCIA slot 60 may receive a smart card device or the like for the purpose of controlling security device 104 with such an input. This could prevent a patient in bed 146 or another unauthorized user from removing or other having access to table computer 10.

The present invention, in the situation of FIG. 5, shows how both a nurse and a doctor may have access to the same medical records. The present invention also allows the tablet computer to be used as a shared electronic medical records clipboard. The tablet computer could simply be slotted into the stand for common access by the doctor and the nurse. Then, if the tablet computer needs to be moved by either the doctor or nurse, then, upon entering the needed biometric data, for example, the doctor or nurse could remove tablet computer 10 from holding device 142 to, for example, use tablet computer 10 as a clipboard or other manual input device.

The biometric security processes that the present invention enable may determine authorized users who may remove tablet computer 10 from the docking station of holding device 142. As such, with the physical security features of security device 104, for example, a tablet computer 10 can be specified to be accessible to only a physician or, alternatively, to clinical staff of a hospital. Likewise, tablet computer 10 may be accessible to only those individuals associated with a particular patient or specific function. Thus, using biometric algorithms, it is possible to set parameters for the use and removal of tablet computer 10 according to differing needs.

The present invention may also accommodate the use of a wireless signals, such as Blue Tooth, the IEEE 802.11 series of signals or other wireless signal. Such signals may be used to both upload user data, as well as to download lists of authorized users. As such, those individuals authorized to remove table computer from docking station 100 or holding device 142 may change dynamically, given the correct algorithms and security procedures to accomplish them.

A technical advantage of the present invention includes allowing multiple levels of authorization. Thus, although a user may be allowed to use a given tablet computer, depending on the user, there may be limitations on the data or applications to user-specific access to data and user-specific access to the tablet computer. Security device 106 may also be set to activate if the authorized user does not input data for a specified amount of time, e.g., 10 seconds. Such a feature could be programmed into a dashboard or other system utility, such as the Motion Computing Dashboard utility.

The present invention also makes possible the tracking of resources such as tablet computer 10. By providing a log of who has received access to the device, the electronic proof of which doctors or other health care providers have accessed specific information, as the tablet computer to moves about a hospital ward, becomes recorded. For regulatory requirements such those of the U.S. Health Insurance Portability Protection Act (HIPPA), such information may become exceedingly important.

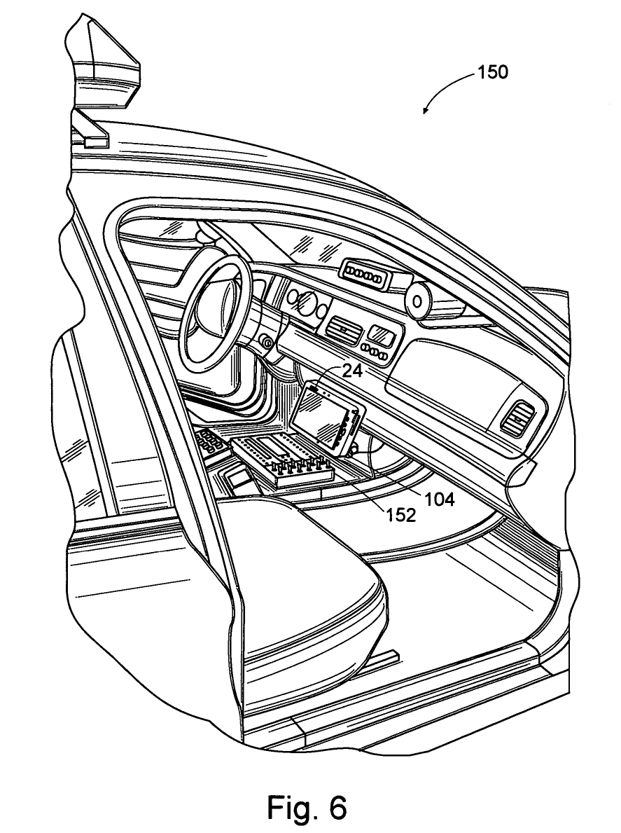

The healthcare environment is not the only environment in which the physical security aspects of the present invention may be applied. FIG. 6 depicts yet another implementation of the present invention, wherein a police or other utility service vehicle 150 may secure tablet computer 10 using security device 104. Thus, in the example, a policeman may use car station 152 to securely hold tablet computer 10 in position. Then, upon swiping fingerprint reader 24, the policeman may remove tablet computer 10 from police vehicle 150. As such, security device 104 provides a maximum degree of physical security in many applications in which secure physical positioning and electronic control of such position or holding of tablet computer 10 is desired.

Another example use of the present invention may be that of healthcare facility or large retail establishment, wherein many tablet computers may be user in a coordinated manner. In such an enterprise or facility, a number of tablet computers could be placed in a clipboard or other arrangement. Then, on a daily basis there could be an accounting of all such tablet computers. Such tablet computers could, for example be collected or checked end of the day in. Then, at the start of a new day, the tablet computers could be singly secured using security device 104, only later to be centrally authorized for removal from the docking station 100 at days end.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A system for controllably and selectively securing a portable computing device to a physical holding device, comprising:
a secured physical holding device for receiving a portable computing device;
a locking mechanism for locking the portable computing device to said physical holding device;
a security application associated with said portable computing device for responding to an authorization input for generating an electronic locking mechanism control signal; and
an actuator mechanism for responding to said electronic locking mechanism control signal to actuate said locking mechanism in locking the portable computing device to said physical holding device.

2. The system of claim 1, wherein the portable computing device belongs to a set of associated portable computing devices and further wherein said actuation mechanism further comprises circuitry for associating the portable computing device with said set of portable computing devices for permitting the physical removal of more than one portable computing devices from said set of portable computing devices upon the receipt of an actuation signal from a master controlling computing device.

3. The system of claim 2, wherein said set of portable computing devices associates with a physical inventory application for accounting for the physical presence of each of said set of portable computing devices.

4. The system of claim 2, wherein said set of portable computing devices associate with a physical inventory application for accounting for the physical presence of each of said set of portable computing devices.

5. The system of claim 1, wherein said portable computing device comprises a tablet personal computer.

6. The system of claim 1, further wherein said system associates with a wall mount for receiving the portable computing device.

7. The system of claim 1, further comprising a fingerprint sensor for actuating said actuator mechanism.

8. The system of claim 1, further comprising a biometric sensor device for actuating said actuator mechanism.

9. The system of claim 1, further comprising a wireless receiver for receiving a wireless signal for actuating said actuator mechanism.

10. The system of claim 9, further comprising circuitry for dynamically communicating authorized user data for actuating said actuator mechanism.

11. The system of claim 10, wherein said authorized user data comprises a list of authorized users for actuating said actuator mechanism.

12. The system of claim 1, further comprising circuitry for dynamically communicating and making effective alternative algorithms and security procedures for actuating said actuator mechanism.

13. The system of claim 12, wherein said alternative algorithms comprise varying levels of authorization for actuating said actuator mechanism.

14. The system of claim 1, further comprising circuitry for controlling actuation of said actuator mechanism according to a time measurement for providing an input to said security application.

15. The system of claim 13, further comprising instructions associated with a dashboard control utility associated with an operating system for the portable computing device for controlling actuation settings for actuation of said actuator mechanism.

16. The system of claim 1, further comprising instructions associated with said security application for tracking the location of said portable computing device.

17. The system of claim 1, further comprising logging instructions associated with said security application for recording access attempts to the portable computing device.

18. The system of claim 1, further comprising means for associating said security devices with a vehicle for controllable securing said portable computing device to said vehicle.

19. The system of claim 1, further comprising a biometric sensor for associating with said security application for actuating said actuator mechanism.

20. A method for controllably and selectively securing a portable computing device to a secured physical holding device, comprising the steps of:
receiving a portable computing device in a physical holding device;
locking the portable computing device to said physical holding device using a locking mechanism;
responding to an authorization input for generating an electronic locking mechanism control signal using a security application associated with said portable computing device; and
responding to said electronic locking mechanism control signal to actuate said locking mechanism in locking the portable computing device to said physical holding device using an actuator mechanism.

21. The method of claim 20, wherein the portable computing device belongs to a set of associated portable computing devices and further comprising the step of associating the portable computing device with said set of portable computing devices for permitting the physical removal of more than one portable computing devices from said set of portable computing devices upon the receipt of an actuation signal from a master controlling computing device.

22. The method of claim 21, further comprising the step of accounting for the physical presence of each of said set of portable computing devices.

23. The method of claim 21, further comprising the step of associating said set of portable computing devices with a physical inventory application for accounting for the physical presence of each of said set of portable computing devices.

24. The method of claim 20, further comprising the step of receiving a receive tablet computer in a wall mount device.

25. The method of claim 20, further comprising the step of actuating said actuator mechanism using a fingerprint sensor.

26. The method of claim 20, further comprising the step of receiving a wireless signal for actuating said actuator mechanism.

27. The method of claim 26, dynamically communicating authorized user data for actuating said actuator mechanism.

28. The method of claim 20, further comprising the step of dynamically communicating and making effective alternative algorithms and security procedures for actuating said actuator mechanism.

29. The method of claim 20, controlling actuation of said actuator mechanism according to a time measurement for providing an input to said security application.

30. The method of claim 20, further comprising the step of tracking the location of said portable computing device instructions using a tracking application associated with said security application.

31. The method of claim 20, further comprising the step of recording access attempts to the portable computing device logging instructions associated with said security application.

32. The method of claim 20, further comprising means for associating said security devices with a vehicle for controllable securing said portable computing device to said vehicle.
